(19) United States
(12) Patent Application Publication
(10) Pub. No.: US 2007/0184363 A1
(43) Pub. Date: Aug. 9, 2007

(54) METHOD OF MANUFACTURING A BLACK MATRIX OF COLOR FILTER

(76) Inventors: Sung-woong KIM, Suwon-si (KR); Wou-sik Kim, Suwon-si (KR); Tao-woon Cha, Seoul (KR); Ki-deok Bae, Yongin-si (KR); Seong-jin Kim, Seongnam-si (KR); Seung-joo Shin, Seoul (KR); Seog-soon Baek, Suwon-si (KR)

Correspondence Address: STANZIONE & KIM, LLP, 919 18TH STREET, N.W., SUITE 440, WASHINGTON, DC, 20006, US

(21) Appl. No.: 11/559,046

(22) Filed: Nov. 13, 2006

(30) Foreign Application Priority Data
Feb. 4, 2006 (KR) 2006-10922
Feb. 4, 2006 (KR) 2006-10924

(51) Int. Cl. G02B 5/20

(52) U.S. Cl. 430/7

(57) ABSTRACT

A method of manufacturing a black matrix of a color filter includes forming a light-shielding layer of a hydrophobic organic material on a surface of a transparent substrate, forming a blocking layer of a fluorinated resin on a top surface of the light-shielding layer, patterning the light-shielding layer and the blocking layer to form the black matrix, the black matrix having a top surface formed with the blocking layer, and heating the black matrix formed with the blocking layer and irradiating UV light towards an upper portion of the black matrix.

### CROSS-REFERENCE TO RELATED APPLICATIONS

This application claims priority under 35 U.S.C. §119(a) from Korean Patent Application No. 10-2006-0010922, filed on Feb. 4, 2006, and Korean Patent Application No. 10-2006-0010924, filed on Feb. 4, 2006, in the Korean Intellectual Property Office, the disclosures of which are incorporated herein in their entireties by reference.

### BACKGROUND OF THE INVENTION

1. Field of the Invention

The present general inventive concept relates to a method of manufacturing a black matrix of a color filter, and more particularly, to a method of manufacturing a black matrix of a color filter in order to improve a brightness uniformity of light.

2. Description of the Related Art

Cathode ray tube (CRT) monitors have been widely used to display information processed in electronic media devices, such as TVs or computers. Recently, as requirements for large-sized screens have increased, flat panel display devices, such as liquid crystal displays (LCDs), plasma display panels (PDPs), organic light emitting diodes (OLEDs), light emitting diodes (LEDs), and field emission displays (FEDs), have been introduced. Since a power consumption of LCDs is small, the LCDs have been commonly used for computer monitors and notebooks.

In general, an LCD includes a color filter through which white light modulated by a liquid crystal layer passes to form an image in desired colors. Conventionally, the color filter includes red (R), green (G), and blue (B) pixels arrayed in a predetermined structure on a transparent substrate. The R, G, and B pixels are partitioned by black matrices.

FIG. 1 is a view illustrating a phenomenon in which inks filling spaces partitioned by black matrices of a conventional color filter mix with each other. FIG. 2 is a view illustrating a phenomenon in which light leaks from spaces partitioned by black matrices of a conventional color filter due to inks insufficiently filling the spaces.

Referring to FIG. 1, a black matrix 11 is formed by coating a transparent substrate 10 with a light-shielding layer to a predetermined thickness, baking the light-shielding layer, and patterning the baked light-shielding layer in a predetermined shape. If the black matrix 11 has a hydrophilic property such that a contact angle of the black matrix 11 with ink is small, an ink 13 from a pixel 15 overflows into an adjacent pixel 16 and mixes with an ink 14 of the adjacent pixel 16. To overcome the aforementioned problem, the black matrix 11 must have a hydrophobic property by which the contact angle with ink is large. Black matrices 21 having such a hydrophobic property are illustrated in FIG. 2.

Referring to FIG. 2, since the black matrix 21 has a hydrophobic property such that a contact angle of the black matrix 21 with ink is large, an ink 23 in a pixel 25 is prevented from overflowing into an adjacent pixel 26 and mixing with an ink 24 of the adjacent pixel 26. However, it is difficult to coat a transparent substrate 20 and obtain a uniform ink thickness thereon. Therefore, light leaks from side wall portions 27 of the black matrix 21, so that a brightness of light emitted through the color filter from each pixel becomes non-uniform.

To solve the aforementioned problem, conventional methods of flatly coating a transparent substrate with inks are illustrated in FIGS. 3, 4A and 4B. FIG. 3 is a view illustrating an “Ink-jet printing method and apparatus for manufacturing color filters” disclosed in the United States Patent Application Publication No. 2003-0030715. FIGS. 4A and 4B are views illustrating an “Ink-jet manufacturing process and device for color filters” disclosed in United States Patent Application Publication No. 2003-0108804.

Referring to FIG. 3, a black matrix 31 is formed on a transparent substrate 30, a pixel 34 partitioned by the black matrix 31 is coated with an ink 32, and air is blown over a surface of the ink 32 using an air nozzle 33 to flatly coat the pixel 34 with the ink 32.

Referring to FIGS. 4A and 4B, after a pixel 43 partitioned by a printing frame 41 is formed on a transparent substrate 40, a shielding film 42 is formed on the printing frame 41, and electrodes 51 and 52 are respectively installed below and above the printing frame 41. When an electric field 50 is generated by applying a voltage to the electrodes 51 and 52 after the pixel 43 is coated with an ink 60, a contact angle between the ink 60 and the printing frame 41 decreases to flatten a surface of the ink 60, as illustrated in FIG. 4B.

However, in the aforementioned conventional method of coating the pixel 34 with the ink 32 by blowing the air over the surface of the ink 32 using the air nozzle 33, it is difficult to supply the air for drying and flattening surfaces of inks in all pixels of the color filter before the inks dry. Moreover, a flatness of the surface of the inks may deteriorate due to characteristics of the inks. Also, since conductive inks are used in the conventional method of flatting the surface of the ink 60 by applying the electric field 50 to the pixel 43, it is difficult to implement this conventional method.

### SUMMARY OF THE INVENTION

The present general inventive concept provides a method of manufacturing a black matrix of a color filter to prevent inks from mixing with each other and to improve a brightness uniformity of light.

Additional aspects and advantages of the present general inventive concept will be set forth in part in the description which follows and, in part, will be obvious from the description, or may be learned by practice of the general inventive concept.

The foregoing and/or other aspects and utilities of the present general inventive concept may be achieved by providing a method of manufacturing a black matrix of a color filter, the method including forming a light-shielding layer of a hydrophobic organic material on a surface of a transparent substrate, forming the black matrix by patterning the light-shielding layer, forming a blocking layer on a top surface of the black matrix, and heating the black matrix formed with the blocking layer and irradiating UV light towards an upper portion of the black matrix.

The foregoing and/or other aspects and utilities of the present general inventive concept may also be achieved by providing a method of manufacturing a black matrix of a color filter, the method including forming a light-shielding layer of a hydrophobic organic material on a surface of a transparent substrate, forming a blocking layer comprising a fluorinated resin on a top surface of the light-shielding layer, patterning the light-shielding layer and the blocking layer to form the black matrix, the black matrix having a top surface formed with the blocking layer thereon, and heating the black matrix formed with the blocking layer and irradiating a UV light towards an upper portion of the black matrix.

The foregoing and/or other aspects and utilities of the present general inventive concept may also be achieved by providing a color filter of a display device, the color filter including a transparent substrate, and at least one black matrix formed on the transparent substrate, the at least one black matrix comprising a bottom surface to contact the transparent substrate, a hydrophobic top surface opposite to the bottom surface, and a hydrophilic side portion between the top and bottom surfaces.

The color filter may further include a blocking layer formed on the top surface of the at least one black matrix. The blocking layer may include a fluorinated resin the at least one black matrix include first and second black matrices spaced apart from each other on the transparent substrate by a predetermined distance to form a space to contain ink.

The foregoing and/or other aspects and utilities of the present general inventive concept may also be achieved by providing an intermediate structure to form a color filter of a display apparatus, the intermediate structure including a transparent substrate, a hydrophobic organic layer formed on the substrate, and a fluorinated resin layer formed on the hydrophobic organic layer.

The foregoing and/or other aspects and utilities of the present general inventive concept may also be achieved by providing a method of manufacturing a color filter of a display device, the method including forming at least one black matrix on a transparent substrate, the at least one black matrix comprising a bottom surface to contact the transparent substrate, a hydrophobic top surface opposite to the bottom surface, and a hydrophilic side portion between the top and bottom surfaces.

The method may further include forming a blocking layer on the top surface of the at least one black matrix. The blocking layer may include a fluorinated resin. The forming of the at least one black matrix on the transparent substrate may include forming first and second black matrices on the transparent substrate spaced apart from each other by a predetermined distance to form a space to contain ink.

The foregoing and/or other aspects and utilities of the present general inventive concept may also be achieved by providing a method of manufacturing a color filter of a display device, the method including forming a hydrophobic layer on a transparent substrate, forming a blocking layer on the hydrophobic layer, patterning the hydrophobic layer to form a plurality of matrices, each matrix including a top portion and side portions, and heating the plurality of matrices and treating the side portions of the plurality of matrices to have hydrophilic properties with respect to color ink of the color filter.

The treating of the side portions of the plurality of matrices to have the hydrophilic properties may include exposing the plurality of matrices to UV light. The hydrophobic layer may be patterned before the blocking layer is formed thereon, and the blocking layer may be formed on the top portions of the plurality of matrices. The blocking layer may be formed on the hydrophobic layer before the hydrophobic layer is patterned, and the hydrophobic layer and the blocking layer may both be patterned to form the plurality of matrices. The blocking layer may include a fluorinated resin. The fluorinated resin may have a UV light transmittance of 90% or more. The hydrophobic layer may be a light-sensitive material.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a view illustrating a phenomenon in which inks filling spaces partitioned by black matrices of a conventional color filter mix with each other;

FIG. 2 is a view illustrating a phenomenon in which light leaks from spaces partitioned by black matrices of a conventional color filter due to inks insufficiently filling the spaces;

FIGS. 3, 4A, and 4B are views illustrating conventional methods of flatly coating a transparent substrate with ink;

FIGS. 5A to 5D are views illustrating a method of manufacturing black matrices of a color filter, according to an embodiment of the present general inventive concept;

FIGS. 6A to 6D are views illustrating a method of manufacturing black matrices of a color filter, according to another embodiment of the present general inventive concept;

FIG. 7 is a view illustrating an example of a molecular formula of a fluorinated resin used in a blocking layer of FIGS. 6B-6D, according to an embodiment of the present general inventive concept;

FIG. 8 is a photograph illustrating a color filter, according to an embodiment of the present general inventive concept, manufactured by filling spaces partitioned by black matrices having side walls that are not treated to have a hydrophilic property with respect to a color ink;

FIG. 9 is a cross sectional view illustrating a profile of the color filter illustrated in FIG. 8;

FIG. 10 is a photograph illustrating a color filter, according to an embodiment of the present general inventive concept, manufactured by filling spaces partitioned by black matrices having side walls that are treated to have a hydrophilic property with respect to a color ink; and

FIG. 11 is a cross sectional view illustrating a profile of the color filter illustrated in FIG. 10.

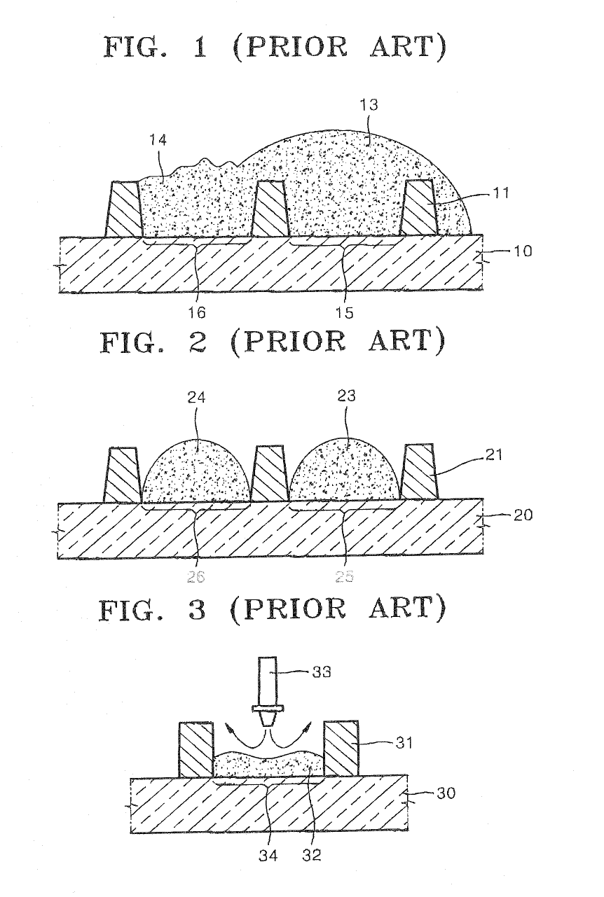

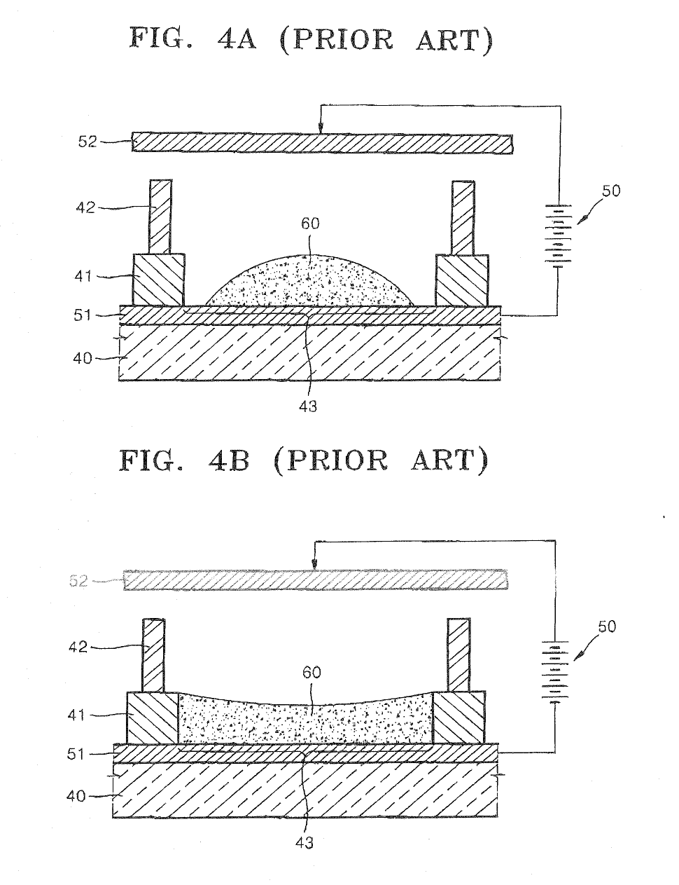

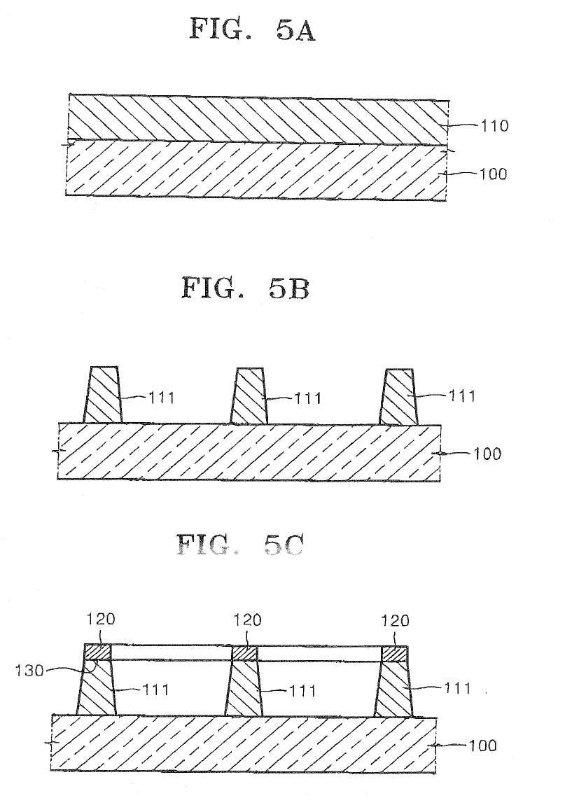

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

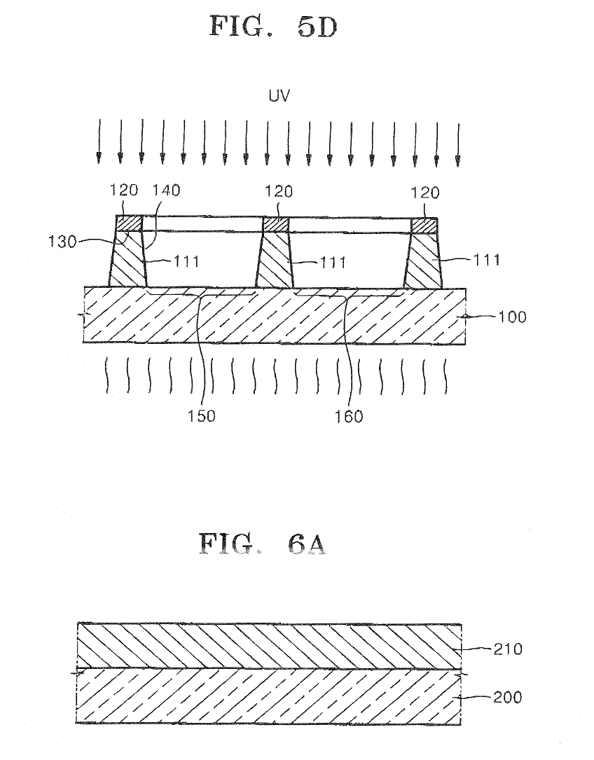

FIGS. 5A to 5D are views illustrating a method of manufacturing a black matrix of a color filter, according to an embodiment of the present general inventive concept.

Referring to FIG. 5A, a hydrophobic organic material is coated to a predetermined thickness on a surface of a transparent substrate 100 and softly baked to form a light-shielding layer 110. The transparent substrate 100 may be made of, for example, a glass substrate or a plastic substrate. The hydrophobic organic material may be coated on the surface of the transparent substrate 100 by, for example, a spin coating method, a die coating method, or a dip coating method.

Referring to FIG. 5B, a black matrix 111 is formed by patterning the light-shielding layer 110 in a predetermined shape. When the light-shielding layer 110 is made of a photosensitive material, as illustrated in FIG. 5B, the light-shielding layer 110 may be developed by light exposure using a photo mask (not shown) on which predetermined patterns are formed. Alternatively, the light-shielding layer 110 may be made of a non-photosensitive material. When the light shielding layer 110 is made of the non-photosensitive material, a photoresist (not shown) may be coated on the surface of the light-shielding layer 110 and patterned through a photolithography process. After that, the light-shielding layer 110 may be etched using the patterned photoresist as an etch mask.

Referring to FIG. 5C, a blocking layer 120 is formed on a top surface (upper surface) 130 of the black matrix 111, which is the patterned light-shielding layer 110 made of either the photosensitive material or the non-photosensitive material The blocking layer 120 may be used as the photo mask when the light-shielding layer 110 is made of the photosensitive material. In contrast, when the light-shielding layer 110 is made of the non-photosensitive material, the blocking layer 120 may be used as the patterned photoresist (or etch mask). For example, when the light-shielding layer 110 is made of the non-photosensitive material, the photoresist may be coated on the surface of the light-shielding layer 110 of FIG. 5A and patterned through the photolithography process. After that the blocking layer 120 may be formed by etching the photoresist to remain only on top surface 130 of the black matrix 111. In other words, the photoresist remaining on the top surface 130 of the black matrix 111 is the blocking layer 120.

Referring to FIG. 5D, the black matrix 111 may be heated and ultraviolet (UV) light may be irradiated towards the upper surface 130 of the black matrix 111. If the black matrix 111 is only irradiated with the UV light (i.e., without heating the black matrix 111), a contact angle of side wall surfaces (side walls) 140 of the black matrix 111 with ink may not change to a desired angle. Therefore, the black matrix 111 should be heated. More specifically when the black matrix 111 is heated while being irradiated with UV light, the contact angle of the side wall surfaces 140 can be easily changed. The heating temperature of the black matrix 111 may be, for example, about 100° C. or higher.

Through the aforementioned processes illustrated in FIGS. 5A-5D, contact angles of the side wall surfaces (side walls) 140 of the black matrix 111 that are exposed to the UV light become different from contact angles of the top surface 130 of the black matrix 111 that is not exposed to the UV light due to the blocking layer 120. More specifically the side walls 140 of the black matrix 111 adsorb moisture from air and thus have a hydrophilic property so that a surface energy thereof increases. However, the top surface 130 of the black matrix 111 is not exposed to the UV light due to the blocking layer 120, and as a result, the top surface 130 of the black matrix 111 maintains an original hydrophobic property.

Table 1 summarizes experimental data of a time-varying of a surface energy of the side walls 140 of the black matrix 111 irradiated with the UV light and experimental data of a time-varying of contact angles between the side walls 140 of the black matrix 111 and water or ink.

TABLE 1

| | 0 sec | 40 sec | 60 sec | 120 sec |
|---|---|---|---|---|
| Surface Energy | 29.1 | 37.6 | 39.2 | 41.5 |
| (mN/m) | | | | |

| | | | | | |
|---|---|---|---|---|---|
| Contact | water | 89.5 | 75.8 | 73.2 | 69.5 |
| Angle | ink A | 29.0 | 28.2 | 26.2 | 4.0 |
| | ink B | 25.7 | 26.2 | 25.4 | 4.0 |
| | ink C | 25.2 | 24.2 | 21.6 | 4.0 |

Referring to Table 1, the surface energy of the side walls 140 of the black matrix 111 irradiated with the UV light increases gradually with time. In addition, the contact angle between the water and the side walls 140 of the black matrix 111 exposed to the UV light decreases gradually with time. The contact angles between the ink and the side walls 140 of the black matrix 111 are generally 20° or more before the irradiation with the UV light, although there may be minor differences therebetween based on compositions of the inks. However, after the irradiation with the UV light, the contact angles decrease gradually to 4° or less, as described in Table 1.

Therefore, the surface energy of the black matrix 111 exposed to the UV light increases with time, and the contact angles thereof decrease with time. In addition, the hydrophobic property of the side walls 140 changes into a hydrophilic property. However, the top surface 130 of the black matrix 111 blocked from the UV light by the blocking layer 120 maintains its original hydrophobic property (i.e., the hydrophobic property of the top surface 130 is not changed into a hydrophilic property).

Accordingly, due to the hydrophobic property of the top surface 130 of the black matrix 111, a color ink filling a space 150 (see FIG. 5D) partitioned by the black matrix 111 is prevented from mixing with another ink filled in an adjacent space 160 (see FIG. 5D). In addition, due to the hydrophilic property of the side walls 140 of the black matrix 111, the color ink fills the space 150 with a uniform thickness so that light is prevented from leaking from the space 150.

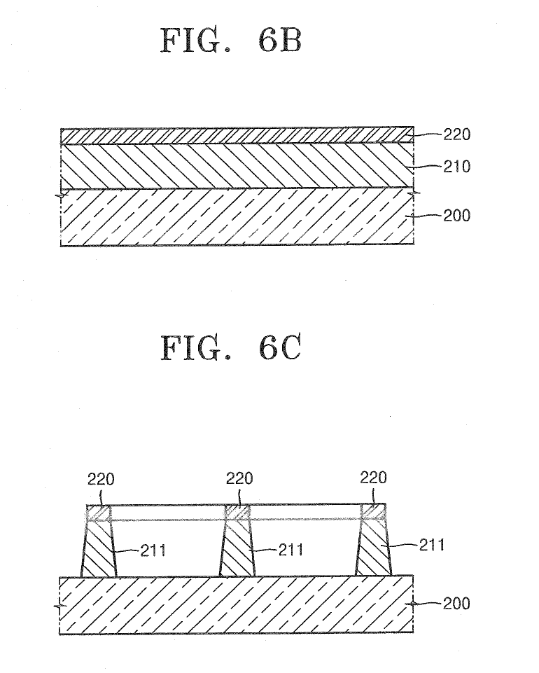

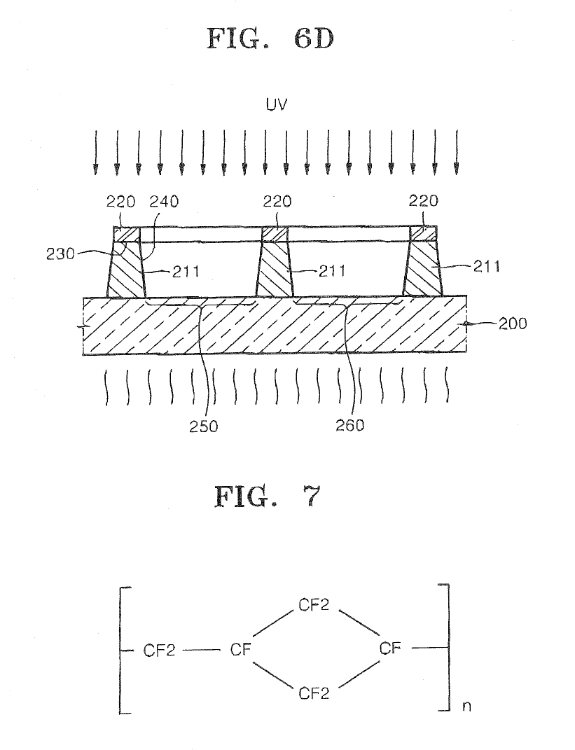

FIGS. 6A to 6D are views illustrating a method of manufacturing a black matrix of a color filter, according to another embodiment of the present general inventive concept.

Referring to FIG. 6A, a hydrophobic organic material is coated to a predetermined thickness on a surface of a transparent substrate 200 and softly baked to form a light-shielding layer 210. Here, the transparent substrate 200 may be, for example, a glass substrate or a plastic substrate. The hydrophobic organic material may be coated on the surface of the transparent substrate 200 by, for example, a spin coating method, a die coating method, or a dip coating method.

Referring to FIG. 6B, a blocking layer 220 is formed on the light-shielding layer 210. The blocking layer 220 may be made of, for example, a fluorinated resin. The blocking layer 220 may be formed to adhere to a top surface of the light-shielding layer 210. The fluorinated resin may have a UV light transmittance of, for example, 90% or more. Therefore, a radical generating reaction does not proceed when the fluorinated resin is exposed to UV light, so that a low surface energy of the fluorinated resin is maintained. More specifically, the surface energy of the fluorinated resin does not change even if the fluorinated resin is exposed to the UV light. Therefore, an original low surface energy of the fluorinated resin is maintained.

FIG. 7 is a view illustrating an example of a molecular formula of the fluorinated resin used in the blocking layer 220 of FIGS. 6B-6D, according to an embodiment of the present general inventive concept. Referring to FIG. 7, a molecular formula of CYTOP™ (manufactured by Asahi Glass Co., Ltd.) is illustrated as an example of the fluorinated resin. The fluorinated resin used in the present embodiment is constructed with a single bond (i.e., “—CF₂—CF—”). If the fluorinated resin is constructed with a double bond, the double bond is broken and the radical generating reaction occurs, resulting in a change in the surface energy of the fluorinated resin. The fluorinated resin is not limited to the example illustrated in FIG. 7, and may be modified in various forms.

Referring to FIG. 6C, a black matrix 211 and the blocking layer 220 are formed by patterning the light-shielding layer 210 and the blocking layer 220 of in FIG. 6B in a predetermined shape.

Referring to FIG. 6D, the black matrix 211 may be heated and UV light may be irradiated towards an upper portion (top surface) 230 of the black matrix 211. If the black matrix 111 is only irradiated with UV light (i.e., without heating the black matrix 211), contact angles of side walls (side wall surfaces) 240 of the black matrix 111 do not change easily to a desired degree. Therefore, the black matrix 111 should be heated. More specifically, when the black matrix 111 is heated while being irradiated with the UV light, the contact angles of the side walls 240 can be easily changed.

Through the aforementioned processes illustrated in FIGS. 6A-6D, the contact angles of side wall surfaces 240 of the black matrix 111 that are exposed to the UV light become different from contact angles of the top surfaces 230 of the black matrix 111 that are not exposed to the UV light.

More specifically, the side walls (side wall surfaces) 240 of the black matrix 211 adsorb moisture from air and thus have a hydrophilic property so that a surface energy thereof increases. However, the blocking layer 220 formed on the top surface 230 of the black matrix 211 transmits most of the UV light, so that a hydrophilic reaction does not occur, thereby maintaining a low surface energy of the top surface 230.

Therefore, due to the blocking layer 220 made of the fluorinated resin, the top surface 230 of the black matrix 211 prevents a color ink in a space 250 formed by the black matrix 211 from overflowing into an adjacent space 260. In addition, the side walls 240 of the black matrix 211 are exposed to the UV light and have the hydrophilic property, thereby decreasing the contact angles of the side wall surfaces 240 of the black matrix 211. Accordingly, a pixel 250 partitioned by the black matrix 211 is filled with color ink to a uniform thickness.

Table 2 summarizes experimental data of a time-varying of a surface energy of the side walls 240 of the black matrix 211 irradiated with the UV light and experimental data of a time-varying of contact angles between the side walls 240 of the black matrix 211 and water or ink.

TABLE 2

| | 0 sec | 40 sec | 60 sec | 120 sec |
|---|---|---|---|---|
| surface energy | 29.1 | 37.6 | 39.2 | 41.5 |
| (mN/m) | | | | |

| | | | | | |
|---|---|---|---|---|---|
| contact | water | 89.5 | 75.8 | 73.2 | 69.5 |
| angle | ink A | 29.0 | 28.2 | 26.2 | 4.0 |
| | ink B | 25.7 | 26.2 | 25.4 | 4.0 |
| | ink C | 25.2 | 24.2 | 21.6 | 4.0 |

Referring to Table 2, the surface energy of the side walls 240 of the black matrix 211 irradiated with the UV light increases with time. In addition, the contact angle between the water and the side walls 240 of the black matrix 211 exposed to the UV light decreases gradually with time. The contact angles between the inks and the side walls 240 of the black matrix 211 are generally 20° or more before the irradiation with the UV light, although there are may be minor differences therebetween based on compositions of the inks. However, after the irradiation with the UV light, the contact angles decrease gradually to 4° or less, as described in Table 2. Therefore, the surface energy of the side walls 240 of the black matrix 211 exposed to the UV light increases with time and the contact angles thereof decrease with time. In addition, the hydrophobic property of the side walls 240 changes into a hydrophilic property.

Table 3 summarizes experimental data of a time-varying of a surface energy and of contact angles of the blocking layer 220 irradiated with the UV light.

TABLE 3

| | | 0 sec | 300 sec |
|---|---|---|---|
| surface energy (mN/m) | | 17.6 | 16.3 |
| contact angle | water | 108 | 110 |
| | ink A | 38 | 42 |

Referring to Table 3, the surface energy of the blocking-layer 220 exposed to the UV light does not change substantially with time. In addition, the contact angles between the blocking layer 211 exposed to the UV light and the water or the ink increase slightly with time. Therefore, the color ink in the pixel 250 does not flow over the blocking layer 220 into another pixel 260. Accordingly, the color ink filling the space 250 partitioned by the black matrix 211 is prevented from mixing with another ink of the adjacent space 260 by the blocking layer 220 formed on the top surface 230 of the black matrix 211. In addition, due to the hydrophilic property of the side walls 240 of the black matrix 211, the color ink fills the pixel 250 with a uniform thickness so that light is prevented from leaking therefrom.

Results obtained by treating the side walls 140 or 240 of the black matrices 111 or 211, respectively to have the hydrophilic property, according to embodiments of the present general inventive concept, are illustrated by the following photographs and profiles.

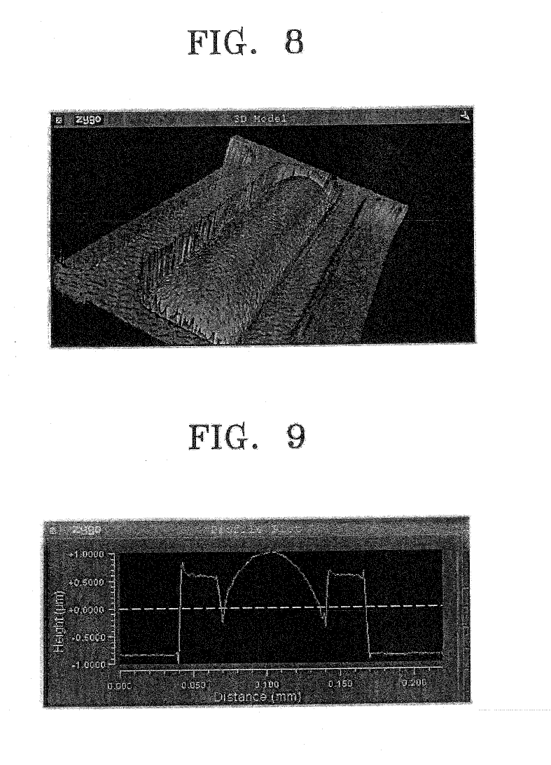

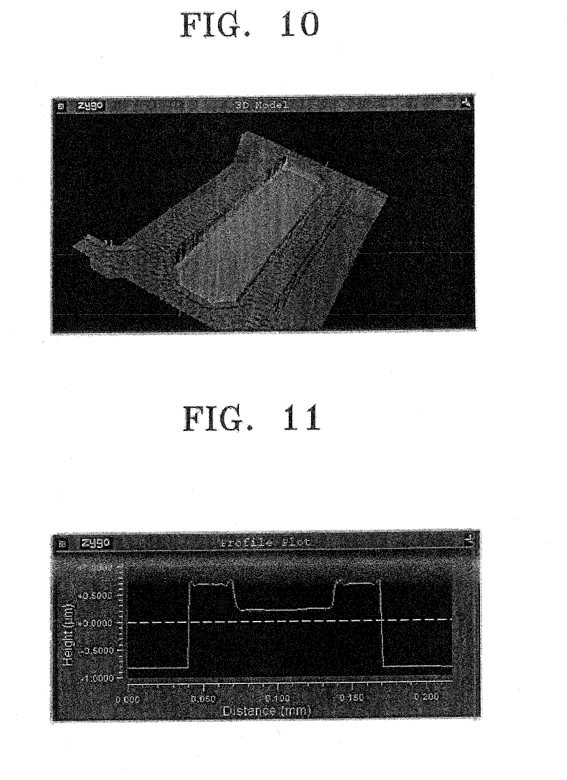

FIG. 8 is a photograph illustrating a color filter, according to an embodiment of the present general inventive concept, manufactured by filling spaces partitioned by black matrices having side portions that are not treated to have a hydrophilic property with respect to a color ink. FIG. 9 is a cross sectional view illustrating a profile of the color filter illustrated in FIG. 8. FIG. 10 is a photograph illustrating a color filter, according to an embodiment of the present general inventive concept, manufactured by filling spaces partitioned by black matrices having side portions that are treated to have a hydrophilic property with respect to a color ink. FIG. 11 is a cross sectional view illustrating a profile of the color filter illustrated in FIG. 10

Referring to FIGS. 8 and 9, when the color ink fills the spaces partitioned by the black matrix (such as the black matrix 111) having sidewalls (such as the sidewalls 140) having a hydrophobic property, contact angles of the color ink with the side walls of the black matrix increases due to the hydrophobic property of the sidewalls, and light leaks therefrom during the irradiation of light.

On the other hand, referring to FIGS. 10 and 11, when the side walls of the black matrix (such as the side walls 140 of the black matrix 111) are changed to have a hydrophilic property using UV light, the color ink flatly fills the spaces partitioned by the black matrix because the contact angles of the side walls of the black matrix with the color ink decrease. Therefore, light is inhibited and/or prevented from leaking therefrom.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A method of manufacturing black matrices of a color filter, the method comprising:
forming a light-shielding layer of a hydrophobic organic material on a surface of a transparent substrate;
forming the black matrix by patterning the light-shielding layer;
forming a blocking layer on a top surface of the black matrix; and
heating the black matrix formed with the blocking layer and irradiating UV light towards an upper portion of the black matrix.

2. The method of claim 1, further comprising:
exposing side walls of the black matrix to the UV light to adsorb moisture from air to increase a surface energy of the side walls.

3. The method of claim 1, wherein the heating of the black matrix comprises:
heating the black matrix at a temperature of above 100° C.

4. The method of claim 1, wherein the forming of the blocking layer comprises:
forming the blocking layer using a photo mask.

5. The method of claim 1, further comprising:
removing the blocking layer formed on the top surface of the black matrix after the irradiating of the UV light towards the upper portion of the black matrix.

6. A method of manufacturing a black matrix of a color filter, the method comprising:
forming a light-shielding layer of a hydrophobic organic material on a surface of a transparent substrate;
forming a blocking layer comprising a fluorinated resin on a top surface of the light-shielding layer;
patterning the light-shielding layer and the blocking layer to form the black matrix, the black matrix having a top surface formed with the blocking layer thereon; and
heating the black matrix formed with the blocking layer and irradiating UV light towards an upper portion of the black matrix.

7. The method of claim 6, further comprising:
exposing side walls of the black matrix to the UV light to adsorb moisture from air to the side walls to increase a surface energy of the side walls.

8. The method of claim 6, wherein the blocking layer transmits the irradiated UV light to maintain a low surface energy of the blocking layer.

9. The method of claim 6, wherein the fluorinated resin forming the blocking layer is constructed with a single bond.

10. A color filter of a display device, the color filter comprising:
a transparent substrate; and
at least one black matrix formed on the transparent substrate, the at least one black matrix comprising a bottom surface to contact the transparent substrate, a hydrophobic top surface opposite to the bottom surface, and a hydrophilic side portion between the top and bottom surfaces.

11. The color filter of claim 10, further comprising:
a blocking layer formed on the top surface of the at least one black matrix.

12. The color filter of claim 11, wherein the blocking layer comprises a fluorinated resin.

13. The color filter of claim 10, wherein the at least one black matrix comprises first and second black matrices spaced apart from each other on the transparent substrate by a predetermined distance to form a space to contain ink.

14. An structure to form a color filter of a display apparatus, the structure comprising:
a transparent substrate;
a hydrophobic organic layer formed on the substrate; and
a fluorinated resin layer formed on the hydrophobic organic layer.

15. A method of manufacturing a color filter of a display device, the method comprising:
forming a hydrophobic layer on a transparent substrate;
forming a blocking layer on the hydrophobic layer;
patterning the hydrophobic layer to form a plurality of matrices, each matrix including a top portion and side portions; and
heating the plurality of matrices and treating the side portions of the plurality of matrices to have hydrophilic properties with respect to color ink of the color filter.

16. The method of claim 15, wherein the treating of the side portions of the plurality of matrices to have the hydrophilic properties comprises:
exposing the plurality of matrices to UV light.

17. The method of claim 15, wherein the hydrophobic layer is patterned before the blocking layer is formed thereon, and the blocking layer is formed on the top portions of the plurality of matrices.

18. The method of claim 15, wherein the blocking layer is formed on the hydrophobic layer before the hydrophobic layer is patterned, and the hydrophobic layer and the blocking layer are both patterned to form the plurality of matrices.

19. The method of claim 18, wherein the blocking layer comprises a fluorinated resin.

20. The method of claim 19, wherein the fluorinated resin has a UV light transmittance of 90% or more.

21. The method of claim 15, wherein the hydrophobic layer is a light-sensitive material.

22. The method of claim 15, wherein the plurality of matrices are spaced apart from each other by a predetermined distance to form spaces to contain ink.
